(19) United States
(12) Patent Application Publication
(10) Pub. No.: US 2015/0009913 A1
(43) Pub. Date: Jan. 8, 2015

(54) APPARATUS AND METHOD FOR CONTROLLING UPLINK POWER OF MOBILE STATION

(71) Applicant: ELECTRONICS AND TELECOMMUNICATIONS RESEARCH INSTITUTE, Daejeon-city (KR)

(72) Inventors: Namsuk LEE, Daejeon (KR); Sookjin LEE, Daejeon (KR)

(73) Assignee: EELECTRONICS AND TELECOMMUNICATIONS RESEARCH INSTITUTE, Daejeon-city (KR)

(21) Appl. No.: 14/322,322

(22) Filed: Jul. 2, 2014

(30) Foreign Application Priority Data
Jul. 4, 2013 (KR) 10-2013-0078559

(51) Int. Cl. H04W 52/14; H04W 72/04

(52) U.S. Cl. CPC H04W 52/146; H04W 72/042
USPC 370/329

(57) ABSTRACT

The present invention relates to an apparatus and method for controlling the uplink power of a mobile station. In the method for controlling uplink power of a mobile station in a wireless communication system, an uplink control channel allocated by a base station is received. A location at which power control information is to be received is determined based on the uplink control channel. Uplink power is controlled based on the power control information at the determined location.

### CROSS REFERENCE TO RELATED APPLICATION

This application claims the benefit of Korean Patent Application No. 10-2013-0078559 filed on Jul. 4, 2013, which is hereby incorporated by reference in its entirety into this application.

### BACKGROUND OF THE INVENTION

1. Technical Field

The present invention relates generally to an apparatus and method for controlling the uplink power of a mobile station and, more particularly, to an apparatus and method for controlling the uplink power of a mobile station, which determine a location at which power control information is to be transmitted based on an uplink control channel in a wireless communication system.

2. Description of the Related Art

In a broadband wireless communication system, uplink power control is configured to reduce signal interference while performing control such that signals transmitted from a terminal (Mobile Station: MS) can be normally received by a Base Station (BS).

For uplink power control, a base station measures the power of uplink signals transmitted from a mobile station. The uplink signals measured at this time are divided into signals received through a control channel and signals received through a data channel. If the base station allocates a control channel to the mobile station, the mobile station periodically transmits control information to the base station. Further, the base station measures signals received through the control channel, and transmits power control-related information to a downlink channel. In this case, the mobile station adjusts uplink transmission power based on the power control-related information.

Such uplink power control methods may be divided into an open-loop power control method and a closed-loop power control method depending on whether the base station has received feedback information from the mobile station.

The open-loop power control method is configured such that a transmitter for performing power control independently determines the channel status of a receiver and performs power control, and is a method of performing control based on the reversibility between downlink and uplink channels. Here, the term “reversibility between uplink and downlink channels” means that mobile stations having the same location against the base station experience similar path attenuation due to path attenuation caused by distances between the base station and the mobile stations, which determines the quality of channels, antenna gain caused by antenna patterns, and shadow effects and multi-path fading caused by geographic features. That is, the open-loop power control method is configured such that a transmitter directly predicts the signal reception quality of a receiver based on the reversibility between uplink and downlink channels, calculates required transmission power, and transmits signals.

The closed-loop control method is configured such that, unlink the open-loop power control method, only required transmission power is controlled based on the signal reception quality of the receiver received through a feedback channel, without allowing the transmitter to independently determine the quality of channels. Such a closed-loop power control method is disadvantageous in that overhead for a feedback channel occurs, but is advantageous in that the transmitter can know the channel quality of the receiver, and thus the intensity of transmission signals may be more accurately controlled compared to the open-loop power control method.

For example, an existing Orthogonal Frequency Division Multiple Access (OFDMA)-based broadband wireless communication system may transmit power control information for all users by using Information Element (IF) forms or terminal identifiers, but is problematic in that overhead for a feedback channel is large.

In relation to this, Korean Patent Application Publication No. 10-2007-0109654 discloses technology entitled “Uplink power control apparatus and method for broadband wireless communication system.”

### SUMMARY OF THE INVENTION

Accordingly, the present invention has been made keeping in mind the above problems occurring in the prior art, and an object of the present invention is to provide an apparatus and method for controlling the uplink power of a mobile station, which determine a location at which power control information is to be transmitted based on an uplink control channel in a wireless communication system, thus performing power control.

In accordance with an aspect of the present invention to accomplish the above object, there is provided an apparatus for controlling uplink power of a mobile station in a wireless communication system, including a channel allocation unit for receiving an uplink control channel allocated by a base station; a location determination unit for determining a location at which power control information is to be received, based on the uplink control channel; and a control unit for controlling uplink power based on the power control information at the determined location.

Preferably, the location determination unit may include a comparison unit for comparing reception processing time (T_rxProc) with a number of uplink subframes (UL) configured in a single frame, wherein the reception processing time includes time at which the power control information transmitted from the base station is received by the mobile station, and time at which feedback information of the power control information, transmitted from the mobile station, is received by the base station; and a determination unit for determining the location at which the power control information is to be received in the downlink subframes (DL) configured in the single frame, based on results of the comparison.

Preferably, the comparison unit may perform comparison using the following formula (1) if the mobile station transmits the feedback information using channel q in an m-th subframe of an i-th frame:

frame=i If T_{—}rxProc<=U−1,i+1

else i+2 (1)

where T_rxProc denotes the reception processing time, and U denotes the number of uplink subframes configured in the single frame.

Preferably, the determination unit may be configured to, if T_rxProc is less than or equal to U−1 for the number of uplink subframes (U) in accordance with formula (1), determine (s mod T)-th location in a floor(s/T)-th downlink subframe of an (i+1)-th frame to be the location at which the power control information is to be received.

Preferably, the determination unit may be configured to, if T_rxProc is greater than U−1 for the number of uplink subframes (U) in accordance with formula (1), determine (s mod T)-th location in a floor(s/T)-th downlink subframe of an (i+2)-th frame to be the location at which the power control information is to be received.

Preferably, the comparison unit may perform comparison using the following formula (2) when the mobile station transmits the feedback information using channel q of an m-th subframe of an i-th frame:

frame=i If T_{—}rxProc<=U−1,i+1

else if T_{—}rxProc−U+1+w<=D,i+1

else i+2

where w=floor(s/T) (2)

where T_rxProc denotes the reception processing time, U denotes the number of uplink subframes configured in the single frame, D denotes a number of downlink subframes configured in a single frame, w denotes floor(s/T), T denotes a number of allocable locations to receive the power control information in downlink subframes, and s denotes an index of the uplink control channel.

Preferably, the determination unit may be configured to, if T_rxProc−U+1+w is less than or equal to the number of downlink subframes (D) in accordance with formula (2), determine (s mod T)-th location in a (T_rxProc−U+1+w)-th downlink subframe of an (i+1)-th frame to be the location at which the power control information is to be received.

Preferably, the determination unit may be configured to, if T_rxProc−U+1+w is greater than the number of downlink subframes (D) in accordance with formula (2), determine (s mod T)-th location in a (T_rxProc−U+1+w mod D)-th downlink subframe of an (i+2)-th frame to be the location at which the power control information is to be received.

In accordance with another aspect of the present invention to accomplish the above object, there is provided a method for controlling uplink power of a mobile station in a wireless communication system, including receiving an uplink control channel allocated by a base station; determining a location at which power control information is to be received, based on the uplink control channel; and controlling uplink power based on the power control information at the determined location.

Preferably, determining the location at which the power control information is to be received may include comparing reception processing time (T_rxProc) with a number of uplink subframes (UL) configured in a single frame, wherein the reception processing time includes time at which the power control information transmitted from the base station is received by the mobile station, and time at which feedback information of the power control information, transmitted from the mobile station, is received by the base station; and determining the location at which the power control information is to be received in the downlink subframes (DL) configured in the single frame, based on results of the comparison.

Preferably, comparing the reception processing time with the number of uplink subframes (UL) configured in the single frame may be performed using the following formula (1) if the mobile station transmits the feedback information using channel q in an m-th subframe of an i-th frame:

frame=i If T_{—}rxProc<=U−1,i+1

else i+2 (1)

where T_rxProc denotes the reception processing time, and U denotes the number of uplink subframes configured in the single frame.

Preferably, determining the location at which the power control information is to be received in the downlink subframes (DL) may be configured to, if T_rxProc is less than or equal to U−1 for the number of uplink subframes (U) in accordance with formula (1), determine (s mod T)-th location in a floor(s/T)-th downlink subframe of an (i+1)-th frame to be the location at which the power control information is to be received.

Preferably, determining the location at which the power control information is to be received in the downlink subframes (DL) may be configured to, if T_rxProc is greater than U−1 for the number of uplink subframes (U) in accordance with formula (1), determine (s mod T)-th location in a floor(s/T)-th downlink subframe of an (i+2)-th frame to be the location at which the power control information is to be received.

Preferably, comparing the reception processing time with the number of uplink subframes (UL) configured in the single frame may be performed using the following formula (2) when the mobile station transmits the feedback information using channel q of an m-th subframe of an i-th frame:

frame=i If T_{—}rxProc<=U−1,i+1

else if T_{—}rxProc−U+1+w<=D,i+1

else i+2

where w=floor(s/T) (2)

where T_rxProc denotes the reception processing time, U denotes the number of uplink subframes configured in the single frame, D denotes a number of downlink subframes configured in a single frame, w denotes floor(s/T), T denotes a number of allocable locations to receive the power control information in downlink subframes, and s denotes an index of the uplink control channel.

Preferably, determining the location at which the power control information is to be received in the downlink subframes (DL) may be configured to, if T_rxProc−U+1+w is less than or equal to the number of downlink subframes (D) in accordance with formula (2), determine (s mod T)-th location in a (T_rxProc−U+1+w)-th downlink subframe of an (i+1)-th frame to be the location at which the power control information is to be received.

Preferably, determining the location at which the power control information is to be received in the downlink subframes (DL) may be configured to, if T_rxProc−U+1+w is greater than the number of downlink subframes (D) in accordance with formula (2), determine (s mod T)-th location in a (T_rxProc−U+1+w mod D)-th downlink subframe of an (i+2)-th frame to be the location at which the power control information is to be received.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an apparatus for controlling the uplink power of a mobile station according to an embodiment of the present invention;

FIG. 2 is a diagram showing the detailed configuration of a location determination unit employed in the apparatus for controlling the uplink power of the mobile station according to an embodiment of the present invention;

FIG. 3 is a flowchart showing the sequence of a method for controlling the uplink power of a mobile station according to an embodiment of the present invention;

FIG. 4 is a flowchart showing the sequence of a location termination method employed in the method for controlling the uplink power of the mobile station according to an embodiment of the present invention;

FIG. 5 is a diagram showing a location determination method according to an embodiment of the present invention;

FIGS. 6 and 7 are diagrams showing examples in which a location is determined based on FIG. 5;

FIG. 8 is a diagram showing a location determination method according to another embodiment of the present invention; and

FIG. 9 is a diagram showing an example in which a location is determined based on FIG. 8.

### DESCRIPTION OF THE PREFERRED EMBODIMENTS

Embodiments of the present invention will be described with reference to the accompanying drawings in order to describe the present invention in detail so that those having ordinary knowledge in the technical field to which the present pertains can easily practice the present invention. It should be noted that same reference numerals are used to designate the same or similar elements throughout the drawings. In the following description of the present invention, detailed descriptions of known functions and constructions which are deemed to make the gist of the present invention obscure will be omitted.

Hereinafter, an apparatus and method for controlling the uplink power of a mobile station according to embodiments of the present invention will be described in detail with reference to the attached drawings.

The present invention relates to an apparatus for controlling the uplink power of a mobile station in a wireless communication system and a method thereof, wherein a base station allocates a Fast Feedback Channel (FFBCH) so that each mobile station periodically transmits Multi Input Multi Output (MIMO) feedback information (feedback info). Further, each mobile station measures a downlink reception signal, and transmits feedback information, such as Channel Quality indicator (CQI) and MIMO-related information, to the base station through the FFBCH. The base station receives feedback information through the FFBCH, measures the power of reception signals, and transmits power control information required to control uplink power to the mobile station.

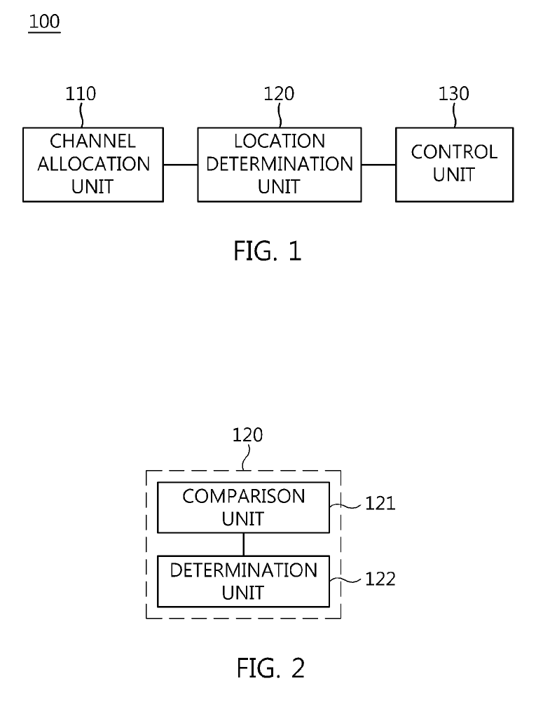

FIG. 1 is a diagram showing the configuration of an apparatus for controlling the uplink power of a mobile station according to an embodiment of the present invention.

Referring to FIG. 1, an apparatus 100 for controlling the uplink power of a mobile station according to an embodiment of the present invention chiefly includes a channel allocation unit 110, a location determination unit 120, and a control unit 130.

The channel allocation unit 110 receives an uplink control channel allocated by the base station. The channel allocation unit 110 estimates an uplink channel by using an FFBCH so as to feed back downlink control channel information among uplink control channels. Below, in the following description, although the FFBCH will be described as an example, other uplink control channels, such as a Channel Quality Indicator (CQI), a ranging channel or an Acknowledgement (ACK) channel, may be used for reference signals of uplink channels. That is, FFBCH, CQI, ranging information, and ACK information correspond to information fed back from the mobile station to the base station.

The location determination unit 120 determines a location, at which power control information is to be received, based on the uplink control channel. The location determination unit 120 determines the location, at which the power control information is to be received, based on the results of a comparison between reception processing time T_rxProc and the number of uplink subframes (UL) configured in a single frame, wherein the reception processing time T_rxProc includes time at which power control information transmitted from the base station is received by the mobile station and time at which feedback information (feedback Info) of power control information, transmitted from the mobile station, is received by the base station. That is, the location determination unit 120 determines the subframe of a frame, in which power control information is to be received from the corresponding base station, in consideration of reception processing time through the uplink control channel. The configuration of the location determination unit 120 will be described in detail later with reference to FIG. 2.

The control unit 130 controls uplink power based on the power control information at the determined location. The control unit 130 may check the location at which the power control information transmitted from the base station is to be received, that is, the indices of a frame and a subframe which include a power control instruction, and may increase or decrease the power of the mobile station to a predetermined bit value depending on the value of the power control information.

FIG. 2 is a diagram showing the configuration of the location determination unit employed in the apparatus for controlling the uplink power of the mobile station according to an embodiment of the present invention.

Referring to FIG. 2, the location determination unit 120 according to the present invention includes a comparison unit 121 and a determination unit 122.

The comparison unit 121 compares reception processing time T_rxProc with the number of uplink subframes (UL) configured in a single frame, wherein the reception processing time T_rxProc includes time at which power control information transmitted from the base station is received by the mobile station and time at which feedback information (feedback Info) of power control information, transmitted from the mobile station, is received by the base station.

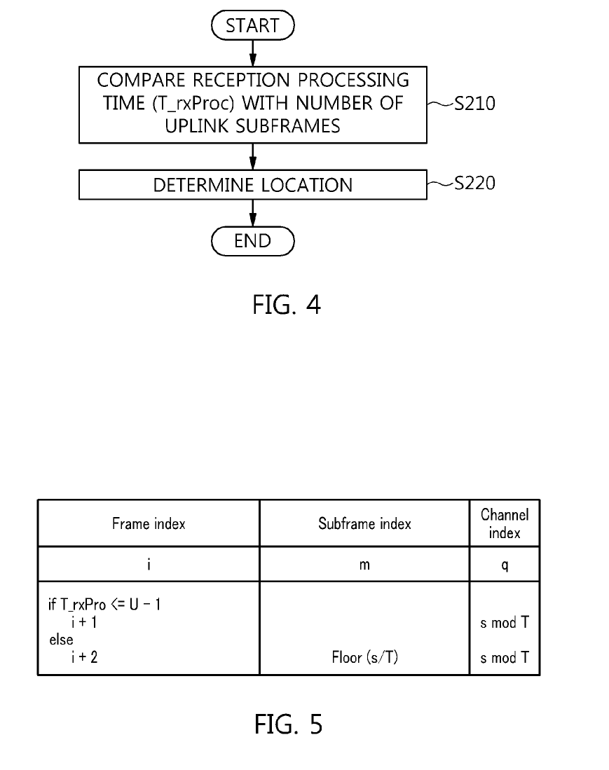

The comparison unit 121 performs the comparison using the following formula (1) or formula (2), which will be described later in FIG. 4, when the mobile station transmits feedback information through the channel q of an m-th subframe in an i-th frame.

The determination unit 122 determines a location, at which power control information is to be received, in downlink subframes (DL) configured in a single frame, based on the results of the comparison by the comparison unit 121. The determination unit 122 determines the location at which the power control information is to be received, based on the results of formula (1) or formula (2) derived by the comparison unit 121.

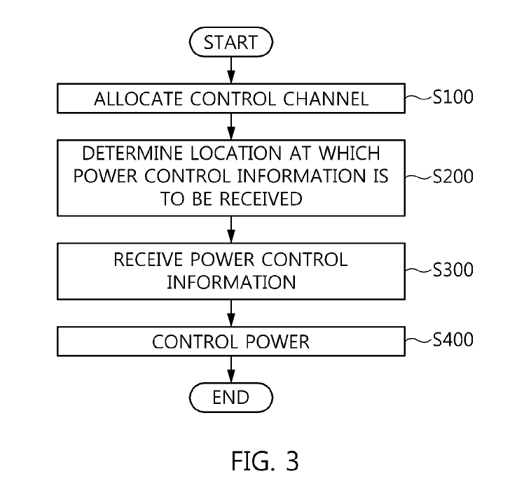

FIG. 3 is a flowchart showing a method for controlling the uplink power of a mobile station according to an embodiment of the present invention.

Referring to FIG. 3, the method for controlling the uplink power of the mobile station according to the present invention is performed by the above-described apparatus 100 for controlling the uplink power of the mobile station, and thus a repeated description thereof will be omitted.

First, the mobile station attempts to initially access a base station, and if such initial access to the base station has succeeded, is allocated a mobile station identifier and an uplink control channel by the base station at step S100. In this case, the uplink control channel may be implemented using an FFBCH, a Channel Quality Indicator (CQI), a ranging channel or an ACK channel. Further, FFBCH information, CQI information, ranging information, or ACK information is information fed back from the mobile station to the base station.

Next, the mobile station determines a location at which power control information is to be received, based on the allocated uplink control channel at step S200. In other words, the mobile station determines a frame and a subframe, in which power control information is to be received from the base station, in consideration of the reception processing time which includes time at which power control information transmitted from the base station through an uplink control channel is received by the mobile station and time at which feedback information (feedback Info) of the power control information, transmitted from the mobile station, is received by the base station. The rules required to determine the indices of a frame and a subframe in which a power control command is to be transmitted will be described in detail later with reference to FIGS. 5 to 9. By means of this, the mobile station may receive power control information even if additional downlink control information is not received from the corresponding base station.

The mobile station checks a location at which the power control information transmitted from the base station is to be received, that is, the indices of a frame and a subframe including the power control information, and receives a power control command if the power control command is included in the corresponding frame at step S300.

Next, the mobile station controls transmission power based on the received power control information at step S400. That is, the mobile station increases or decreases the transmission power in response to the power control information.

Finally, the mobile station transmits feedback information through the allocated uplink control channel. This step may be performed independently of a processor and may be performed anytime after step S100. Further, steps S300 and S400 are periodically performed until feedback is terminated through the uplink control channel.

FIG. 4 is a flowchart showing the sequence of a location determination method employed in the method for controlling the uplink power of the mobile station according to an embodiment of the present invention.

Referring to FIG. 4, the location determination method in the method for controlling the uplink power of the mobile station according to the present invention is configured to compare reception processing time T_rxProc with the number of uplink subframes (UL) configured in a single frame, wherein the reception processing time T_rxProc includes time at which power control information transmitted from the base station is received by the mobile station and time at which the feedback information (feedback Info) of the power control information, transmitted from the mobile station, is received by the base station, at step S210.

Then, based on the results of the comparison, a location at which power control information is to be received is determined in downlink subframes (DL) configured in a single frame at step S220.

The above-described location determination method may be provided in two types, as follows.

First, when the mobile station transmits feedback information using the channel q of an m-th subframe in an i-th frame, the base station and the mobile station calculate the locations at which the power control information is to be transmitted and received, by the following formula (1):

frame=i If T_{—}rxProc<=U−1,i+1

else i+2 (1)

where T_rxProc denotes the reception processing time, and U denotes the number of uplink subframes configured in a single frame.

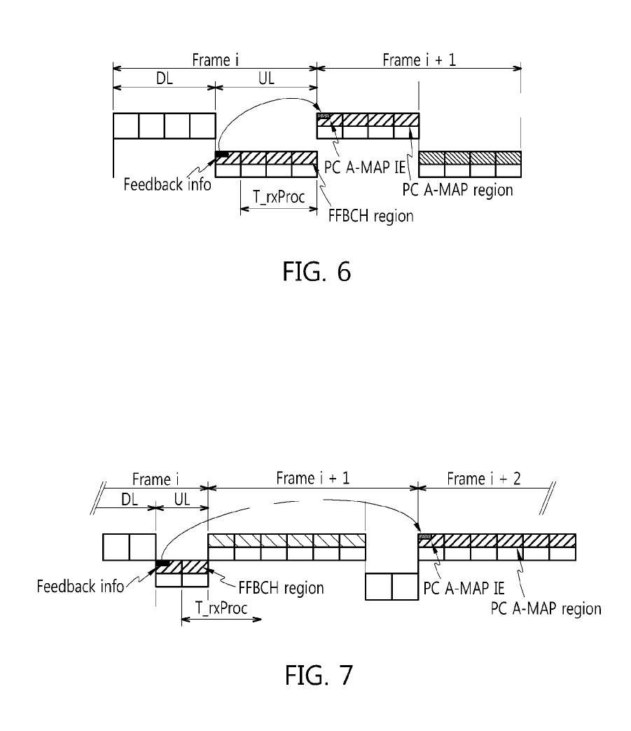

In accordance with formula (1), if T_rxProc is less than or equal to U−1 for the number of uplink subframes U, (s mod T)-th location in the floor (s/T)-th downlink subframe of an (i+1)-th frame may be determined to be the location at which the power control information is to be received. A detailed description thereof will be made later with reference to FIGS. 5 and 6.

Further, in formula (1), if T_rxProc is greater than U−1 for the number of uplink subframes U, (s mod T)-th location in the floor(s/T)-th downlink subframe of an (i+2)-th frame may be determined to be the location at which the power control information is to be received. A detailed description thereof will be made later with reference to FIGS. 5 and 7.

Second, when the mobile station transmits feedback information using the channel q of the m-th subframe in the i-th frame, the base station and the mobile station calculate the locations at which power control information is to be transmitted and received, by the following formula (2):

frame=i If T_{—}rxProc<=U−1,i+1

else if T_{—}rxProc−U+1+w<=D,i+1

else i+2

where w=floor(s/T) (2)

where T_rxProc denotes the reception processing time, U denotes the number of uplink subframes configured in a single frame, D denotes the number of downlink subframes configured in a single frame, w denotes floor(s/T), T denotes the number of allocable locations to receive the power control information in the downlink subframe, and s denotes the index of the uplink control channel (s for FFBCH channel index of the m-th uplink subframe is s=Qmax*m+q).

In accordance with formula (2), if the T_rxProc is less than or equal to U−1 for the number of uplink subframes U, (s mod T)-th location in the floor(s/T)-th downlink subframe of an (i+1)-th frame may be determined to be the location at which the power control information is to be received. A detailed description thereof will be made later with reference to FIGS. 6 and 8.

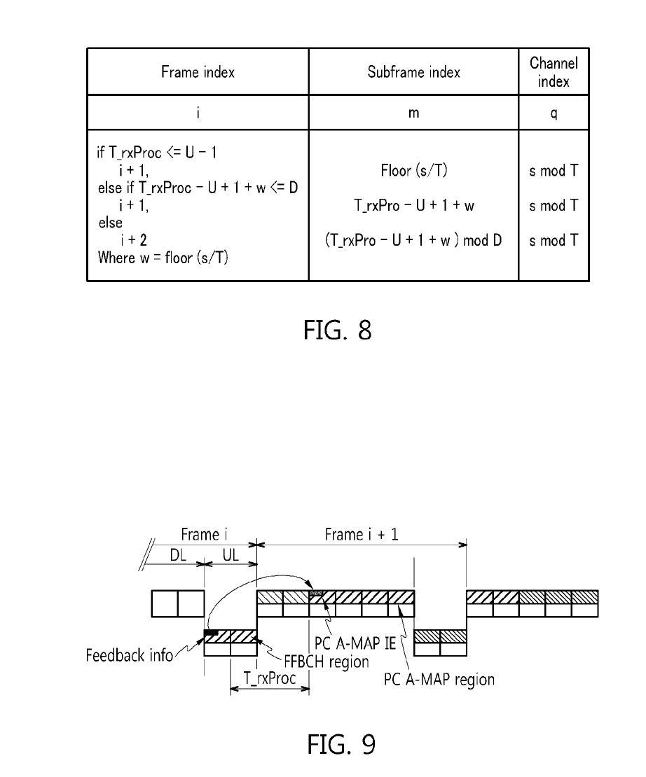

Further, in formula (2), if T_rxProc−U+1+w is less than or equal to the number of downlink subframes D, (s mod T)-th location in the (T_rxProc−U+1+w)-th downlink subframe of the (i+1)-th frame may be determined to be the location at which the power control information is to be received. A detailed description thereof will be made later with reference to FIGS. 8 and 9.

Furthermore, in formula (2), if T_rxProc−U+1+w is greater than the number of downlink subframes D, (s mod T)-th location in the (T_rxProc−U+1+w mod D)-th downlink subframe of an (i+2)-th frame may be determined to be the location at which the power control information is to be received.

FIG. 5 is a diagram showing a location determination method according to an embodiment of the present invention, and FIGS. 6 and 7 are diagrams showing examples in which a location is determined based on FIG. 5.

Referring to FIG. 5, a single frame according to the present invention is composed of eight subframes, and such subframes are divided into uplink subframes (UL) and downlink subframes (DL).

For example, it is assumed that, when the mobile station transmits feedback information (feedback Info) using channel q in the FFBCH region of the m-th subframe of an i-th frame, the base station and the mobile station calculate and determine the locations at which power control information PC A-MAP IE is to be transmitted and received, using the above formula (1).

If T_rxProc is less than or equal to U−1 for the number of uplink subframes U, (s mod T)-th location in the PC A-MAP region of the floor(s/T)-th downlink subframe of an (i+1)-th frame may be determined to be the location at which power control information is to be received, as shown in FIG. 6.

Further, if T_rxProc is greater than U−1 for the number of uplink subframes U, (s mod T)-th location in the PC A-MAP region of the floor(s/T)-th downlink subframe of an (i+2)-th frame may be determined to be the location at which power control information is to be received, as shown in FIG. 7.

FIG. 8 is a diagram showing a location determination method according to another embodiment of the present invention, and FIG. 9 is a diagram showing an example in which a location is determined based on FIG. 8.

Referring to FIG. 8, a single frame according to the present invention is composed of eight subframes, and such subframes are divided into uplink subframes (UL) and downlink subframes (DL).

For example, it is assumed that, when a mobile station transmits feedback information (feedback Info) using channel q in the FFBCH region of the m-th subframe in an i-th frame, the base station and the mobile station calculate and determine locations at which power control information PC A-MAP IE is to be transmitted and received, by using the above formula (2).

If T_rxProc is less than or equal to U−1 for the number of uplink subframes U, (s mod T)-th location in the PC A-MAP region of the floor(s/T)-th downlink subframe of an (i+1)-th frame may be determined to be the location at which the power control information is to be received, as shown in FIG. 6.

Further, if T_rxProc−U+1+w is less than or equal to the number of downlink subframes D, (s mod T)-location in the PC A-MAP region of the (T_rxProc−U+1+w)-th downlink subframe of the (i+1)-th frame may be determined to be the location at which the power control information is to be received, as shown in FIG. 9.

Furthermore, if T_rxProc−U+1+w is greater than the number of downlink subframes D, (s mod T)-th location in the PC A-MAP region of the (T_rxProc−U+1+w mod D)-th downlink subframe of an (i+2)-th frame may be determined to be location at which the power control information is to be received.

As described above, the apparatus and method for controlling the uplink power of the mobile station according to the present invention having the above configuration are advantageous in that a location at which power control information is to be transmitted is determined based on an uplink control channel in a wireless communication system, thus reducing overhead on power control information.

Further, the present invention is advantageous in that, upon determining a location at which power control information is to be transmitted, reception processing time for power control information is taken into consideration, so that uplink power control may be more accurately performed, and the influence of path loss and inter-cell interference caused by uplink power control may be reduced, thus improving the service quality of a wireless communication system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for controlling uplink power of a mobile station in a wireless communication system, comprising:
receiving an uplink control channel allocated by a base station;
determining a location at which power control information is to be received, based on the uplink control channel; and
controlling uplink power based on the power control information at the determined location.

2. The method of claim 1, wherein determining the location at which the power control information is to be received comprises:
comparing reception processing time (T_rxProc) with a number of uplink subframes (UL) configured in a single frame, wherein the reception processing time includes time at which the power control information transmitted from the base station is received by the mobile station, and time at which feedback information of the power control information, transmitted from the mobile station, is received by the base station; and
determining the location at which the power control information is to be received in the downlink subframes (DL) configured in the single frame, based on results of the comparison.

3. The method of claim 2, wherein comparing the reception processing time with the number of uplink subframes (UL) configured in the single frame is performed using the following formula (1) if the mobile station transmits the feedback information using channel q in an m-th subframe of an i-th frame:
frame=i If T_{—}rxProc<=U−1,i+1
else i+2 (1)
where T_rxProc denotes the reception processing time, and U denotes the number of uplink subframes configured in the single frame.

4. The method of claim 3, wherein determining the location at which the power control information is to be received in the downlink subframes (DL) is configured to, if T_rxProc is less than or equal to U−1 for the number of uplink subframes (U) in accordance with formula (1), determine (s mod T)-th location in a floor(s/T)-th downlink subframe of an (i+1)-th frame to be the location at which the power control information is to be received.

5. The method of claim 3, wherein determining the location at which the power control information is to be received in the downlink subframes (DL) is configured to, if T_rxProc is greater than U−1 for the number of uplink subframes (U) in accordance with formula (1), determine (s mod T)-th location in a floor(s/T)-th downlink subframe of an (i+2)-th frame to be the location at which the power control information is to be received.

6. The method of claim 2, wherein comparing the reception processing time with the number of uplink subframes (UL) configured in the single frame is performed using the following formula (2) when the mobile station transmits the feedback information using channel q of an m-th subframe of an i-th frame:
frame=i If T_{—}rxProc<=U−1,i+1
else if T_{—}rxProc−U+1+w<=D,i+1
else i+2
where w=floor(s/T) (2)
where T_rxProc denotes the reception processing time, U denotes the number of uplink subframes configured in the single frame, D denotes a number of downlink subframes configured in a single frame, w denotes floor(s/T), T denotes a number of allocable locations to receive the power control information in downlink subframes, and s denotes an index of the uplink control channel.

7. The method of claim 6, wherein determining the location at which the power control information is to be received in the downlink subframes (DL) is configured to, if T_rxProc−U+1+w is less than or equal to the number of downlink subframes (D) in accordance with formula (2), determine (s mod T)-th location in a (T_rxProc−U+1+w)-th downlink subframe of an (i+1)-th frame to be the location at which the power control information is to be received.

8. The method of claim 6, wherein determining the location at which the power control information is to be received in the downlink subframes (DL) is configured to, if T_rxProc−U+1+w is greater than the number of downlink subframes (D) in accordance with formula (2), determine (s mod T)-th location in a (T_rxProc−U+1+w mod D)-th downlink subframe of an (i+2)-th frame to be the location at which the power control information is to be received.

9. An apparatus for controlling uplink power of a mobile station in a wireless communication system, comprising:
a channel allocation unit for receiving an uplink control channel allocated by a base station;
a location determination unit for determining a location at which power control information is to be received, based on the uplink control channel; and
a control unit for controlling uplink power based on the power control information at the determined location.

10. The apparatus of claim 9, wherein the location determination unit comprises:
a comparison unit for comparing reception processing time (T_rxProc) with a number of uplink subframes (UL) configured in a single frame, wherein the reception processing time includes time at which the power control information transmitted from the base station is received by the mobile station, and time at which feedback information of the power control information, transmitted from the mobile station, is received by the base station; and
a determination unit for determining the location at which the power control information is to be received in the downlink subframes (DL) configured in the single frame, based on results of the comparison.

11. The apparatus of claim 10, wherein the comparison unit performs comparison using the following formula (1) if the mobile station transmits the feedback information using channel q in an m-th subframe of an i-th frame:
frame=i If T_{—}rxProc<=U−1,i+1
else i+2 (1)
where T_rxProc denotes the reception processing time, and U denotes the number of uplink subframes configured in the single frame.

12. The apparatus of claim 11, wherein the determination unit is configured to, if T_rxProc is less than or equal to U−1 for the number of uplink subframes (U) in accordance with formula (1), determine (s mod T)-th location in a floor(s/T)-th downlink subframe of an (i+1)-th frame to be the location at which the power control information is to be received.

13. The apparatus of claim 11, wherein the determination unit is configured to, if T_rxProc is greater than U−1 for the number of uplink subframes (U) in accordance with formula (1), determine (s mod T)-th location in a floor(s/T)-th downlink subframe of an (i+2)-th frame to be the location at which the power control information is to be received.

14. The apparatus of claim 10, wherein the comparison unit performs comparison using the following formula (2) when the mobile station transmits the feedback information using channel q of an m-th subframe of an i-th frame:
frame=i If T_{—}rxProc<=U−1,i+1
else if T_{—}rxProc−U+1+w<=D,i+1
else i+2
where w=floor(s/T) (2)
where T_rxProc denotes the reception processing time, U denotes the number of uplink subframes configured in the single frame, D denotes a number of downlink subframes configured in a single frame, w denotes floor(s/T), T denotes a number of allocable locations to receive the power control information in downlink subframes, and s denotes an index of the uplink control channel.

15. The apparatus of claim 14, wherein the determination unit is configured to, if T_rxProc−U+1+w is less than or equal to the number of downlink subframes (D) in accordance with formula (2), determine (s mod T)-th location in a (T_rxProc−U+1+w)-th downlink subframe of an (i+1)-th frame to be the location at which the power control information is to be received.

16. The apparatus of claim 14, wherein the determination unit is configured to, if T_rxProc−U+1+w is greater than the number of downlink subframes (D) in accordance with formula (2), determine (s mod T)-th location in a (T_rxProc−U+1+w mod D)-th downlink subframe of an (i+2)-th frame to be the location at which the power control information is to be received.
